(19) United States
(12) Patent Application Publication
(10) Pub. No.: US 2009/0041200 A1
(43) Pub. Date: Feb. 12, 2009

(54) Radiation therapy imaging and delivery utilizing coordinated motion of jaws, gantry, and couch

(75) Inventors: Weiguo Lu, Madison, WI (US); Yu Chen, Madison, WI (US); Mingli Chen, Madison, WI (US); Quan Chen, Madison, WI (US); Gustavo H. Olivera, Madison, WI (US); Graham Reitz, Madison, WI (US); Kenneth J. Ruchala, Madison, WI (US); Eric Schnarr, McFarland, WI (US)

Correspondence Address: MICHAEL BEST & FRIEDRICH LLP, 100 E WISCONSIN AVENUE, Suite 3300, MILWAUKEE, WI, 53202, US

(73) Assignee: TomoTherapy Incorporated, Madison, WI (US)

(21) Appl. No.: 12/220,608

(22) Filed: Jul. 26, 2008

Related U.S. Application Data
(63) Continuation-in-part of application No. 11/459,161, filed on Jul. 21, 2006.
(60) Provisional application No. 60/701,585, filed on Jul. 23, 2005.

(51) Int. Cl. G21K 1/04

(52) U.S. Cl. 378/152

(57) ABSTRACT

A method of delivering a radiation therapy treatment plan to a treatment area of a patient. The treatment plan is delivered using a radiation therapy system including a moveable support for supporting a patient, and a gantry moveable relative to the support. The gantry supports a radiation source, a set of jaws having a jaw width and a multi-leaf collimator for modulating the radiation during delivery of the treatment plan. The support is moved during delivery of the treatment plan to the treatment area, and the width of the jaws is dynamically adjusted during delivery of the treatment plan to the treatment area.

### RELATED APPLICATIONS

This application is a continuation-in-part of and claims priority to U.S. patent application Ser. No. 11/459,161 filed on Jul. 21, 2006, which claims priority to U.S. Provisional Patent Application No. 60/701,585, filed on Jul. 23, 2005, titled RADIATION THERAPY IMAGING AND DELIVERY UTILIZING COORDINATED MOTION OF GANTRY, COUCH AND MULTI-LEAF COLLIMATOR. The entire contents of both applications are incorporated herein by reference.

### BACKGROUND

In traditional radiation therapy, a patient lies atop a static treatment couch, and is treated by a static treatment gantry. Often, static blocks are inserted into a beam of radiation to shape the beam. As radiation therapy has advanced, motion has been introduced to improve the quality of treatment and deliver treatments more efficiently.

### SUMMARY

One method in the field of radiation therapy entails simultaneous motion of multi-leaf collimator (“MLC”) leaves while the patient couch and the gantry, holding the radiation source, remain still. This is referred to as dynamic MLC or a sliding-window technique and can improve delivery efficiency of a series of fixed MLC patterns. Another method is to rotate the gantry in arcs concurrently with MLC motion. This is referred to as intensity modulated arc therapy (“IMAT”). Axial radiation therapy combines MLC motion with gantry rotation and couch movement between rotations. A more advanced version, known as helical radiation therapy, entails simultaneous couch motion concurrently with MLC motion and gantry rotation. The combination of gantry rotation and patient translation results in the radiation source following a helical trajectory about the patient.

In one embodiment, the invention provides methods of performing both patient imaging and radiation therapy treatment through new and advanced motion trajectories of the radiation therapy components. These methods include novel ways of delivering treatment and producing imaging using simultaneous couch, MLC motion, and gantry rotation.

One embodiment of the invention includes a method of delivering a radiation therapy treatment plan to a treatment area of a patient using a radiation therapy system. The radiation therapy system includes a moveable support for supporting the patient and a gantry moveable relative to the support, the gantry supporting a radiation source, a set of jaws having a jaw width, and a multi-leaf collimator for modulating the radiation during delivery of the treatment plan. The method includes moving the support along an axis during delivery of the treatment plan to the treatment area, and dynamically adjusting the width of the jaws during the delivery of the treatment plan to the treatment area. The adjustment of the width of the jaws can occur along the entirety of the delivery of the treatment plan to the treatment area.

In another embodiment, the invention provides a method of delivering a radiation therapy treatment plan to a treatment area of a patient using a radiation therapy system. The radiation therapy system includes a moveable support for supporting the patient and a gantry moveable relative to the support, the gantry supporting a radiation source, a set of jaws having a jaw width, and a multi-leaf collimator for modulating the radiation during delivery of the treatment plan. The method includes moving the support along an axis at varying speeds during the delivery of the treatment plan to the treatment area, and moving the gantry relative to the support at varying speeds during the delivery of the treatment plan.

Other aspects of the invention will become apparent by consideration of the detailed description and accompanying drawings.

### BRIEF DESCRIPTION OF THE DRAWINGS

FIG. 1 is a perspective view of a radiation therapy treatment system.

FIG. 2 is a perspective view of a multi-leaf collimator that can be used in the radiation therapy treatment system illustrated in FIG. 1.

FIG. 3 is a schematic illustration of the radiation therapy treatment system of FIG. 1.

FIG. 4 is a schematic diagram of a software program used in the radiation therapy treatment system.

FIG. 5 is a flow chart of a method of delivering radiation therapy treatment to a patient according to one embodiment of the invention.

FIG. 6 is a flow chart of a method of delivering radiation therapy treatment to a patient according to one embodiment of the invention.

FIG. 7 is a flow chart of a method of delivering radiation therapy treatment to a patient according to one embodiment of the invention.

FIG. 8 is a flow chart of a method of delivering radiation therapy treatment to a patient according to one embodiment of the invention.

FIG. 9 is a flow chart of a method of delivering radiation therapy treatment to a patient according to one embodiment of the invention.

FIG. 10 is a flow chart of a method of delivering radiation therapy treatment to a patient according to one embodiment of the invention.

FIG. 11 is a flow chart of a method of delivering radiation therapy treatment to a patient according to one embodiment of the invention.

FIG. 12 is a flow chart of a method of delivering radiation therapy treatment to a patient according to one embodiment of the invention.

FIG. 13 is a graphical representation of the comparison of intended vs. delivered radiation fluence distributions using different jaw widths for fixed jaw therapy.

FIG. 14 is a graphical representation of intended vs. delivered radiation fluence distributions using different jaw widths for running start and stop therapy.

FIG. 15 is a graphical representation of intended vs. delivered radiation fluence distributions using any jaw width for dynamic jaw therapy.

FIG. 16 is a graphical illustration of the comparison of the source and jaw tracks of a dynamic couch treatment delivery vs. a constant speed couch treatment delivery.

FIG. 17 is a workflow representation to calculate certain parameters of dynamic jaw, dynamic couch therapy delivery.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first”, “second”, and “third” are used herein for purposes of description and are not intended to indicate or imply relative importance or significance.

In addition, it should be understood that embodiments of the invention include both hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

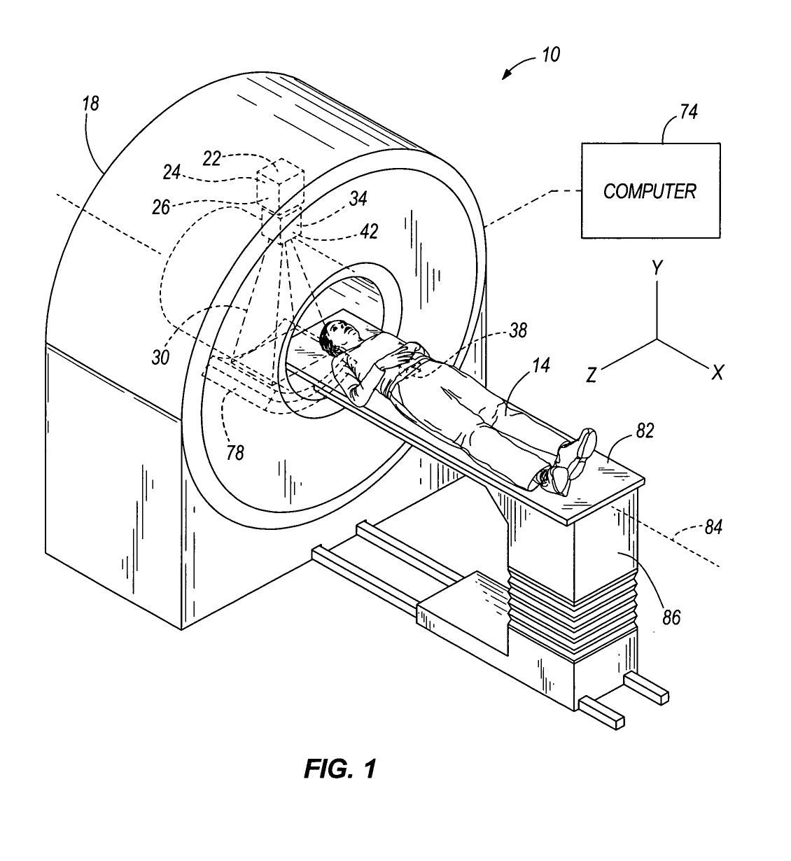

FIG. 1 illustrates a radiation therapy treatment system 10 that can provide radiation therapy to a patient 14. The radiation therapy treatment can include photon-based radiation therapy, brachytherapy, electron beam therapy, proton, neutron, or particle therapy, or other types of treatment therapy. The radiation therapy treatment system 10 includes a gantry 18. The gantry 18 can support a radiation module 22, which can include a radiation source 24 and a linear accelerator 26 operable to generate a beam 30 of radiation. Though the gantry 18 shown in the drawings is a ring gantry, i.e., it extends through a full 360° arc to create a complete ring or circle, other types of mounting arrangements may also be employed. For example, a non-ring-shaped gantry, such as a C-type, partial ring gantry, or robotic arm could be used. Any other framework capable of positioning the radiation module 22 at various rotational and/or axial positions relative to the patient 14 may also be employed. In addition, the radiation source 24 may travel in path that does not follow the shape of the gantry 18. For example, the radiation source 24 may travel in a non-circular path even though the illustrated gantry 18 is generally circular-shaped.

The radiation module 22 can also include a modulation device 34 operable to modify or modulate the radiation beam 30. The modulation device 34 provides the modulation of the radiation beam 30 and directs the radiation beam 30 toward the patient 14. Specifically, the radiation beam 34 is directed toward a portion of the patient. Broadly speaking, the portion may include the entire body, but is generally smaller than the entire body and can be defined by a two-dimensional area and/or a three-dimensional volume. A portion desired to receive the radiation, which may be referred to as a target 38 or target region, is an example of a region of interest. Another type of region of interest is a region at risk. If a portion includes a region at risk, the radiation beam is preferably diverted from the region at risk. The patient 14 may have more than one target region that needs to receive radiation therapy. Such modulation is sometimes referred to as intensity modulated radiation therapy (“IMRT”).

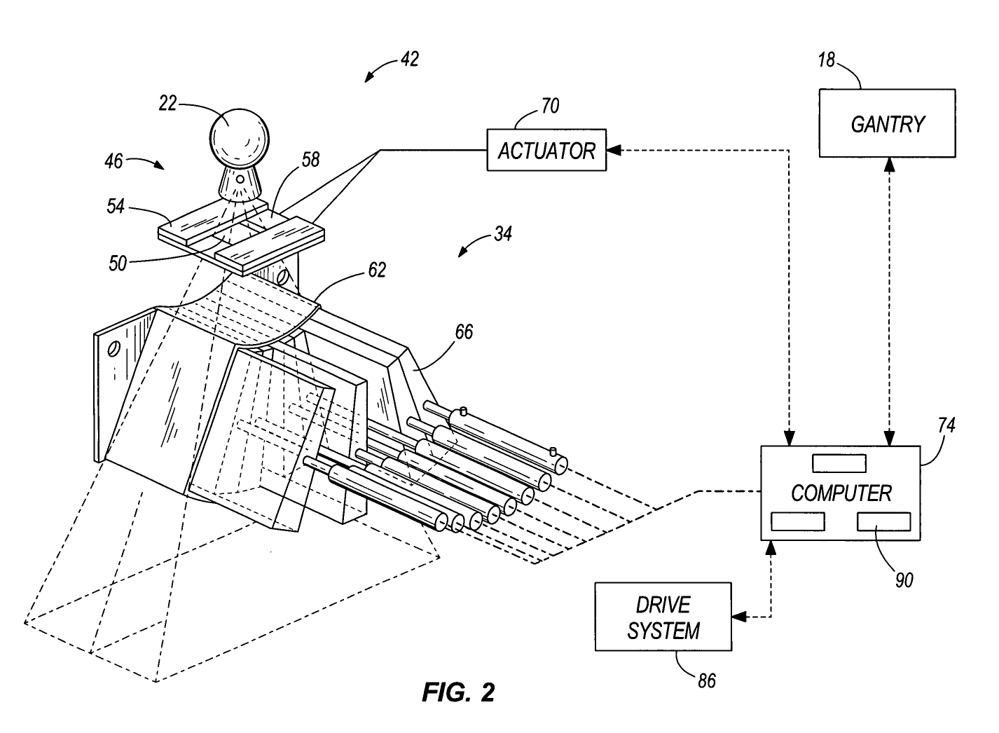

The modulation device 34 can include a collimation device 42 as illustrated in FIG. 2. The collimation device 42 includes a set of jaws 46 that define and adjust the size of an aperture 50 through which the radiation beam 30 may pass. The jaws 46 include an upper jaw 54 and a lower jaw 58. The upper jaw 54 and the lower jaw 58 are moveable to adjust the size of the aperture 50.

In one embodiment, and illustrated in FIG. 2, the modulation device 34 can comprise a multi-leaf collimator 62, which includes a plurality of interlaced leaves 66 operable to move from position to position, to provide intensity modulation. It is also noted that the leaves 66 can be moved to a position anywhere between a minimally and maximally-open position. The plurality of interlaced leaves 66 modulate the strength, size, and shape of the radiation beam 30 before the radiation beam 30 reaches the target 38 on the patient 14. Each of the leaves 66 is independently controlled by an actuator 70, such as a motor or an air valve so that the leaf 66 can open and close quickly to permit or block the passage of radiation. The actuators 70 can be controlled by a computer 74 and/or controller.

The radiation therapy treatment system 10 can also include a detector 78, e.g., a kilovoltage or a megavoltage detector, operable to receive the radiation beam 30. The linear accelerator 26 and the detector 78 can also operate as a computed tomography (CT) system to generate CT images of the patient 14. The linear accelerator 26 emits the radiation beam 30 toward the target 38 in the patient 14. The target 38 absorbs some of the radiation. The detector 78 detects or measures the amount of radiation absorbed by the target 38. The detector 78 collects the absorption data from different angles as the linear accelerator 26 rotates around and emits radiation toward the patient 14. The collected absorption data is transmitted to the computer 74 to process the absorption data and to generate images of the patient's body tissues and organs. The images can also illustrate bone, soft tissues, and blood vessels.

The CT images can be acquired with a radiation beam 30 that has a fan-shaped geometry, a multi-slice geometry or a cone-beam geometry. In addition, the CT images can be acquired with the linear accelerator 26 delivering megavoltage energies or kilovoltage energies. It is also noted that the acquired CT images can be registered with previously acquired CT images (from the radiation therapy treatment system 10 or other image acquisition devices, such as other CT scanners, MRI systems, and PET systems). For example, the previously acquired CT images for the patient 14 can include identified targets 38 made through a contouring process. The newly acquired CT images for the patient 14 can be registered with the previously acquired CT images to assist in identifying the targets 38 in the new CT images. The registration process can use rigid or deformable registration tools.

In some embodiments, the radiation therapy treatment system 10 can include an x-ray source and a CT image detector. The x-ray source and the CT image detector operate in a similar manner as the linear accelerator 26 and the detector 78 as described above to acquire image data. The image data is transmitted to the computer 74 where it is processed to generate images of the patient's body tissues and organs.

The radiation therapy treatment system 10 can also include a patient support, such as a couch 82 (illustrated in FIG. 1), which supports the patient 14. The couch 82 moves along at least one axis 84 in the x, y, or z directions. In other embodiments of the invention, the patient support can be a device that is adapted to support any portion of the patient's body. The patient support is not limited to having to support the entire patient's body. The system 10 also can include a drive system 86 operable to manipulate the position of the couch 82. The drive system 86 can be controlled by the computer 74.

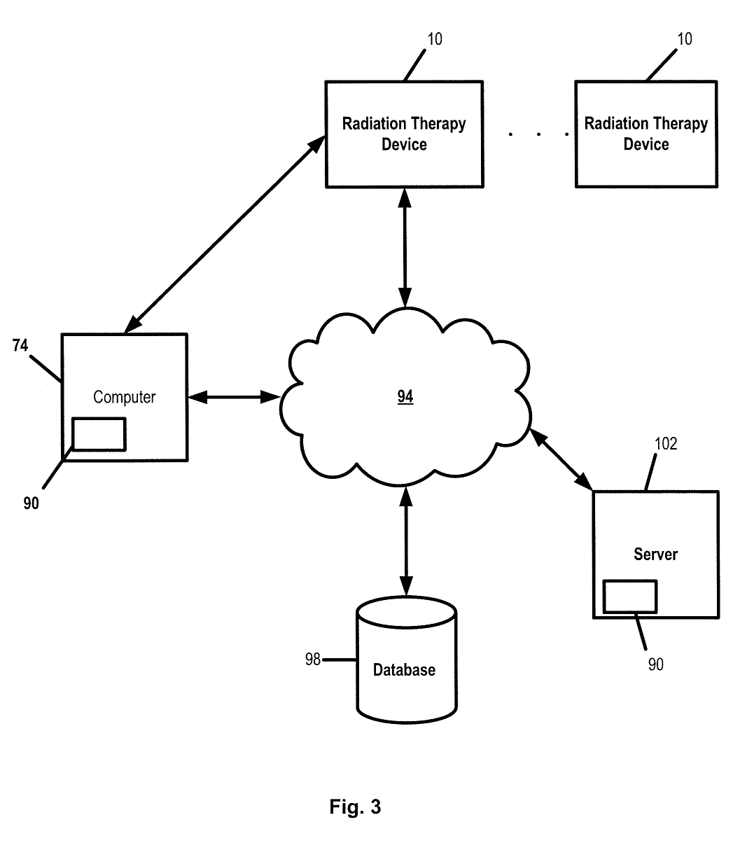

The computer 74, illustrated in FIGS. 2 and 3, includes an operating system for running various software programs and/or a communications application. In particular, the computer 74 can include a software program(s) 90 that operates to communicate with the radiation therapy treatment system 10. The computer 74 can include any suitable input/output device adapted to be accessed by medical personnel. The computer 74 can include typical hardware such as a processor, I/O interfaces, and storage devices or memory. The computer 74 can also include input devices such as a keyboard and a mouse. The computer 74 can further include standard output devices, such as a monitor. In addition, the computer 74 can include peripherals, such as a printer and a scanner.

The computer 74 can be networked with other computers 74 and radiation therapy treatment systems 10. The other computers 74 may include additional and/or different computer programs and software and are not required to be identical to the computer 74, described herein. The computers 74 and radiation therapy treatment system 10 can communicate with a network 94. The computers 74 and radiation therapy treatment systems 10 can also communicate with a database(s) 98 and a server(s) 102. It is noted that the software program(s) 90 could also reside on the server(s) 102.

The network 94 can be built according to any networking technology or topology or combinations of technologies and topologies and can include multiple sub-networks. Connections between the computers and systems shown in FIG. 3 can be made through local area networks (“LANs”), wide area networks (“WANs”), public switched telephone networks (“PSTNs”), wireless networks, Intranets, the Internet, or any other suitable networks. In a hospital or medical care facility, communication between the computers and systems shown in FIG. 3 can be made through the Health Level Seven (“HL7”) protocol or other protocols with any version and/or other required protocol. HL7 is a standard protocol which specifies the implementation of interfaces between two computer applications (sender and receiver) from different vendors for electronic data exchange in health care environments. HL7 can allow health care institutions to exchange key sets of data from different application systems. Specifically, HL7 can define the data to be exchanged, the timing of the interchange, and the communication of errors to the application. The formats are generally generic in nature and can be configured to meet the needs of the applications involved.

Communication between the computers and systems shown in FIG. 3 can also occur through the Digital Imaging and Communications in Medicine (DICOM) protocol with any version and/or other required protocol. DICOM is an international communications standard developed by NEMA that defines the format used to transfer medical image-related data between different pieces of medical equipment. DICOM RT refers to the standards that are specific to radiation therapy data.

The two-way arrows in FIG. 3 generally represent two-way communication and information transfer between the network 94 and any one of the computers 74 and the systems 10 shown in FIG. 3. However, for some medical and computerized equipment, only one-way communication and information transfer may be necessary.

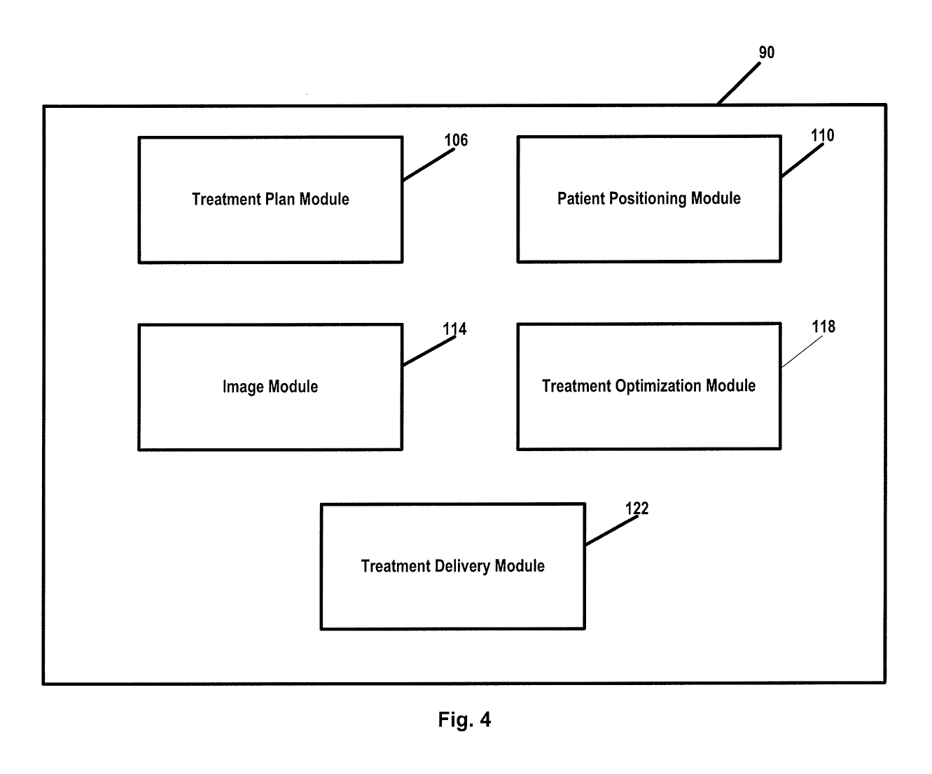

FIG. 4 is a schematic illustration of the software program 90. The software program 90 includes a plurality of modules that communicate with one another to perform functions of the radiation therapy treatment process. The various modules are adapted to communicate with one another to deliver radiation therapy to the patient 14.

The software program 90 includes a treatment plan module 106 operable to generate a treatment plan for the patient 14 based on data input to the system 10 by medical personnel. The data includes one or more images (e.g., planning images and/or pre-treatment images) of at least a portion of the patient 14. The treatment plan module 106 separates the treatment into a plurality of fractions and determines the radiation dose for each fraction or treatment based on the prescription input by medical personnel. The treatment plan module 106 also determines the radiation dose for the target 38 based on various contours drawn around the target 38. Multiple targets 38 may be present and included in the same treatment plan.

The software program 90 also includes a patient positioning module 110 operable to position and align the patient 14 with respect to the isocenter of the gantry 18 or other reference for a particular treatment fraction. While the patient 14 is on the couch 82, the patient positioning module 110 acquires an image of the patient 14 and compares the current position of the patient 14 to the position of the patient in a planning or previously acquired image. If the patient's position needs to be adjusted, the patient positioning module 110 provides instructions to the drive system 86 to move the couch 82, or the patient 14 can be manually moved to a new position.

In one aspect, the patient positioning module 110 can receive data from lasers positioned in the treatment room to provide patient position data with respect to the isocenter of the gantry 18 or other reference. Based on the data from the lasers, the patient positioning module 110 provides instructions to the drive system 86, which moves the couch 82 to achieve proper alignment of the patient 14 with respect to the gantry 18 or other reference. It is noted that devices and systems, other than lasers, can be used to provide data to the patient positioning module 110 to assist in the alignment process.

The software program 90 also includes an image module 114 operable to acquire images of at least a portion of the patient 14. The image module 114 can instruct the on-board image device, such as a CT imaging device to acquire images of the patient 14 before treatment commences, during treatment, and after treatment according to desired protocols. In one aspect, the image module 114 acquires an image of the patient 14 while the patient 14 is substantially in a treatment position. Other imaging devices may be used to acquire pre-treatment images of the patient 14, such as non-quantitative CT, MRI, PET, SPECT, ultrasound, transmission imaging, fluoroscopy, RF-based localization, and the like. The acquired images can be used for registration of the patient 14.

The software program 90 can include a treatment optimization module 118 operable to optimize the treatment plan generated by the treatment plan module 106. In particular, the optimization module 118 generates the commands or instructions for the radiation therapy treatment system 10 necessary to optimally deliver the treatment plan. The optimization module 118 is operable to determine and select between various parameters of operation of the radiation therapy treatment system 10 based on the type of treatment the patient 14 is going to receive and/or the mode of operation of the radiation therapy treatment system 10. Some of the parameters include, but are not limited to, position of the leaves 66, gantry angles and angular speed, speed of the drive system 86, type of motion of the couch 82, size of the jaw aperture 50, couch range of motion, and radiation beam intensity.

The optimization module 118 allows a technician or health care professional to select a mode of operation for the radiation therapy treatment system 10 and related devices assisting in radiation therapy. The modes of operation can include a manual mode, a semi-automatic mode, an automatic mode, or a combination of these modes. Alternatively, the software program 90 and/or the optimization module 118 can include sub-modules operable to selectively adjust parameters of the radiation therapy treatment system 10 pertaining to specific stages of radiation treatment.

The optimization module 118 communicates with the treatment plan module 106 to determine the settings for the radiation therapy treatment system 10 based on the type of treatment that is to be delivered as set forth in the treatment plan. In one type of treatment plan delivery, the radiation therapy treatment system 10 can be configured to position the patient 14 on the couch 82 and deliver radiation to the patient 14 by moving the couch 82, at least partially, through the gantry opening at least on one occasion while the gantry 18 is maintained at a set position or angle. This is sometimes referred to as topotherapy. It is noted that the entire length of the patient 14 does not need to pass through the gantry opening, but rather, any portion of the patient can pass or lie within the gantry opening. It is also noted that the couch 82 can move in a step-wise fashion, in a constant linear motion, and/or a combination of both types of motion. In this aspect, the desired gantry angle(s) can be selected for one or more, at least partial, passes of the patient 14 through the gantry opening. The health care professional can also specify other parameters of the radiation therapy treatment system 10. In some aspects, the optimization module 118 can automatically set the parameters of the radiation treatment therapy system 10 for each pass of the patient 14 through the gantry 18 opening. The parameters automatically set by the optimization module 118 can include, but are not limited to, number of passes of the patient 14 through the gantry 18 opening, gantry angle(s), speed of the drive system, couch range of motion, size of the jaw aperture 45, and radiation beam intensity.

The optimization module 118 can also provide instructions to the image module 114 to perform topographic and/or tomographic imaging of the patient 14 using the radiation therapy treatment system 10. The optimization module 118 can select various settings for topographic and/or tomographic imaging including the number of passes that the patient 14 travels through the gantry opening, gantry angles, speed of the drive system 86, couch range of motion, size of the jaws aperture 50, and radiation beam intensity.

The optimization module 118 can include a scan-plan-treat mode. The scan-plan-treat mode includes a sequence of scanning the patient 14, generating a treatment plan, and treating the patient 14 in one session using the radiation therapy treatment system 10 without interruption. The radiation therapy treatment system 10 integrates positioning of the patient 14, treatment planning, and delivery of the plan in a single system. There is less need to transport the patient 14 to numerous departments in a medical facility for radiation therapy. As a result of the system integration and use of geometric shapes to identify contours in some circumstances, a patient 14 can be treated in approximately 20 minutes or less. For example, it should take about two minutes to position the patient 14 on the couch 82, about three to about six minutes to acquire the CT images, about three minutes to identify the contours, about two minutes to generate the treatment plan, and about three minutes to deliver the plan.

In some aspects, the optimization module 118 provides optimization methods for one or more topographic passes. These can be manually implemented by the user, or automatically implemented by the system 10. These methods include identifying and/or optimizing preferred gantry angles, pitches, gantry speeds, jaw aperture, couch speed, and/or couch range of motion.

Another embodiment of the invention includes extending the target 38 to include a wider area. This process is sometimes referred to as leaf flashing and involves increasing the area of the radiation beam 30 in response to motion of the patient 14 during treatment. For example, some organs of the patient 14 may expand and contract as the patient 14 receives radiation therapy treatment. The leaf flashing process can utilize pre-treatment and/or during-treatment images to determine the additional margin(s) around the target 38 that may need treatment. For example, a pre-determined target 38 located at the breast area of a patient 14 can be treated with the leaf flashing procedure. The breast area can contract and expand as the patient 14 breathes. The leaf flashing procedure allows a health care professional to observe changes of the breast area in the form of images and to adjust the radiation treatment to cover the margin(s) of the target 38 during at least a fraction of the overall treatment. Alternatively, the optimization module 118 can include instructions for the radiation therapy treatment system 10 to automatically perform the leaf flashing procedure by obtaining images and adjusting the treatment based on the images and expected changes in the anatomy of the patient 14. The computer 74 running the optimization module 118 may also perform topotherapy treatment and tomographic imaging automatically or under the supervision of a qualified user.

In another type of treatment plan delivery, the radiation therapy treatment system 10 can be configured to position the patient 14 on the couch 82 and deliver radiation to the patient 14 by moving the couch 82, at least partially, through the gantry opening at least on one occasion while the gantry 18 is rotated along a defined path. The defined path of gantry rotation is in a short arc or between a first position and a second position, where the second position is different than the first position. The defined path is less than a complete circle. This type of gantry movement combined with movement of the couch 82 is sometimes referred to as dynamic tangent.

The patient 14 undergoes an imaging procedure to obtain images that assist in identifying the target(s) 38. Based on the image(s) and/or treatment plan, the optimization module 118 can identify a start angle and an end angle for the defined path of travel of the gantry 18. The optimization module 118 can determine other parameters of the radiation therapy treatment system 10 such as range of motion of the couch 82, helix spacing, size of the jaw aperture 50, and speed of the drive system 86. The optimization module 118 provides instructions to the radiation therapy treatment system 10 to rotate the gantry 18 from the first or start position to the second or end position and to project the radiation beam 30 toward the target 38 while the couch 82 moves the patient 14 into and through the gantry opening.

The dynamic tangent procedure can also be performed as the patient 14 is moved out of the gantry opening. For example, as the patient 14 is moving through and out of the gantry opening the gantry 18 can rotate from the second or end position to the first or start position. A health care professional can view and adjust the operational parameters such as start position, end position, speed of the drive system 86, and couch range of motion for each pass through the gantry opening.

The radiation therapy treatment system 10 can deliver the treatment plan using helices of either common or opposite chirality (i.e., the direction of rotation of the helix relative to its axis), or multiples of both. Opposite chirality is achieved by reversing either the direction of movement of the couch or direction of gantry rotation for a delivery pass after a previous delivery pass.

In various aspects of the invention, treatment options can include changing gantry speeds and/or directions during imaging or treatment; changing couch speeds and/or directions during treatment; completing entire treatment passes before switching direction of the gantry; changing direction of the gantry to deliver higher or lower doses of radiation to the patient; changing direction of the gantry to correct for errors or patient motion; and/or using predictive gating to anticipate errors or patient motion and compensate for any lags in the detection/correction process. Additionally, any of the aforementioned embodiments of the dynamic tangent technique can be combined with simultaneous discrete or continuous motion of the couch 82, or of the patient using an external device. Such motion can be either discrete or continuous, and may be performed at a constant or variable rate with any combinations of translations or rotations comprising the movement.

Further embodiments include optimization of delivery through automatic detection and/or clinical observation of the patient's breathing patterns. This can include manually setting the breathing pauses, or automatically gating the linear accelerator or MLC based upon a patient movement device. In the event that the patient's breathing hinders delivery of the treatment plan, e.g., the patient's breathing becomes erratic, the procedure could continue without radiation (beam off or leaves closed) until the patient's breathing stabilizes. In this event, the system 10 can record the missed regions of the treatment. The missed regions can be cumulated into make-up procedures and run as appropriate (daily, weekly, monthly, etc.) depending on amount of radiation missed and clinical necessity.

The dynamic tangent treatment can also be combined with tomographic or topographic imaging, in which an image(s) is obtained as the patient 14 receives radiation therapy treatment. Images can be acquired by stopping or slowing the dynamic tangent procedure and employing the radiation source 24 to acquire the image or images. Once images are acquired, the dynamic tangent procedure may continue. Some alternatives include acquiring images when the gantry 18 is at the first position. Other alternatives are to acquire images at angles between the first or start position and the second or end position of the gantry 18. Based on the images obtained during treatment, a health care professional may selectively adjust the parameters of the radiation therapy treatment system 10 for subsequent passes of the patient 14, or these parameters may be adjusted automatically. Alternatively, the optimization module 118 can include instructions to automatically set dynamic tangent parameters such as the first or start position, second or end position, gantry speed, couch range of motion, speed of the drive system 86, size of the jaw aperture 50, and the position of the leaves 66.

In another type of treatment plan delivery, a back-and-forth gantry motion is combined with movement of the couch 82. In this type of treatment plan delivery, the radiation therapy treatment system 10 can be configured to position the patient 14 on the couch 82 and deliver radiation to the patient 14 by moving the couch 82, at least partially, through the gantry opening at least on one occasion while the gantry 18 rotates along a defined path in a back-and-forth motion. The defined path of gantry rotation is in a short arc or between a first position and a second position, where the second position is different than the first position. The defined path is less than a complete circle. This is sometimes referred to as rocking gantry.

The patient 14 undergoes an imaging procedure to obtain images that assist in identifying the target(s) 38. Based on the image(s) and/or treatment plan, the optimization module 118 can identify a start angle and an end angle for the defined path of travel of the gantry 18. The optimization module 118 can determine other parameters of the radiation therapy treatment system 10 such as range of motion of the couch 82, helix spacing, size of the jaw aperture 50, and speed of the drive system 86. The optimization module 118 provides instructions to the radiation therapy treatment system 10 to rotate the gantry 18 in a back-and-forth manner along the path between the first or start position to the second or end position and to project the radiation beam 30 toward the target 38 while the couch 82 moves the patient 14 into and through the gantry opening.

The rocking gantry method of treatment may also include tomographic or topographic imaging of the patient 14 in which an image(s) is obtained as the patient 14 receives radiation treatment. Images can be acquired by selectively stopping the gantry 18 at an angle between the start position and the end position, obtaining an image or images, and resuming treatment. Based on the images obtained during treatment, a health care professional can adjust the parameters of the radiation therapy treatment system 10 for subsequent passes of the patient 14.

The rocking gantry procedure can also be performed as the patient 14 is moved out of the gantry opening. For example, as the patient 14 is moving through and out of the gantry opening the gantry 18 can rotate in a back-and-forth manner from the second or end position to the first or start position. A health care professional can view and adjust the operational parameters such as start position, end position, speed of the drive system 86, and couch range of motion for each pass through the gantry opening.

Another aspect of the invention includes adjusting the radiation therapy treatment system parameters to provide therapy to the patient 14 with a plurality of identified targets 38. This is referred to as multiple region treatment and involves providing radiation treatment to a first target 38 and automatically proceeding to provide treatment to a subsequent target 38. This can provide efficient and automatic treatment to disparate targets 38. Targets 38 may require different types of treatments such as rocking gantry or dynamic tangent. The multiple region treatment procedure can incorporate various types of treatments by automatically adjusting parameters such as the size of the jaw aperture 50, position of the leaves 66, speed of the drive system 86, and couch range of motion, for each target 38 to be treated. In one pass of the patient 14 through the gantry opening, the multiple region treatment procedure can automatically adjust the position of the patient 14 between treatment sequences.

Topographic imaging may also be incorporated with the multiple region treatment procedure. Similar to other treatment procedures, CT images can be selectively acquired by stopping or slowing the radiation therapy treatment system 10 at a desired location, acquiring one or more CT images and subsequently continuing treatment. Based on the CT images obtained during treatment, a health care professional can selectively adjust treatment for each target 38 being treated. Alternatively, the optimization module 118 can include instructions to automatically determine the number of targets 38 to be treated, adjust the radiation therapy treatment system parameters for each treatment according to the characteristics of the targets 38, and reposition the patient 14 between treatments.

Another aspect of the invention includes concurrent cone beam CT (“CBCT”) imaging for radiation treatments with couch motion. This process can be combined with movement of the gantry 18. This combination is referred to as helical trajectory CBCT because the radiation source 24 follows a helical path around the patient 14 as the patient 14 is moved into the gantry opening at a constant speed. Another aspect is concurrent couch motion with a static gantry 18. The radiation source 24 for CBCT imaging maintains a constant position as the patient 14 is moved by the couch 82 under the influence of the drive system 86 at a constant speed. Another aspect is concurrent couch motion with gantry rotation between a start angle and an end angle for CBCT imaging. CBCT images can be obtained while the gantry 18 rotates from the start angle to the end angle and the patient 14 is moved through the gantry opening by the couch 82. The gantry 18 can also rotate in a back-and-forth motion between the start angle and end angles as the patient 14 is moved by couch 82.

Another aspect of the invention is concurrent motion of the couch 82 with other imaging systems such as, but not limited to, PET, SPECT or MRI. Alternatively, the optimization module 118 can automatically select the operational parameters of the radiation therapy treatment system 10 for concurrent CBCT imaging, or other imaging procedures, and couch 82 motion under predetermined conditions can be selected by a health care professional.

Another aspect of the invention includes adjusting the parameters of the radiation therapy treatment system 10 to generate CT images of a plurality of the targets 38. In particular, a health care professional may adjust the parameters of the radiation therapy treatment to acquire CT images at a target 38 and proceed to a subsequent target 38 during one pass of the patient 14 through the gantry opening. Transporting the patient 14 to acquire CT images from one region to the subsequent region may require adjusting the radiation therapy treatment system parameters such as speed of the drive system 86, range of motion of the couch 82, and gantry angle. Alternatively, the optimization module 118 can automatically set the appropriate parameters for obtaining CT images in a region of interest, repositioning the patient 14, and setting appropriate parameters for CT imaging in subsequent region or regions.

Another aspect of the invention includes adjusting parameters of the radiation therapy treatment system 10 dynamically during the delivery of the treatment to the patient 14 according to the treatment plan. Dynamic adjustment of certain parameters or components of the treatment system 10 functions to modulate the amount of radiation received by the patient 14 (or more specifically, the target 38) in ways similar to adjusting the leaves 66 of the multi-leaf collimator 62.

In one embodiment, a treatment plan can be more efficiently delivered through modulation of the speed of the couch 82 and/or gantry 18 during delivery of the treatment plan than can be achieved with modulation of the multi-leaf collimator 62 alone. For treatment delivery using a constant couch speed, the speed of the couch 62 is determined by the portion of the treatment that requires the longest exposure time within the treatment area or target 38 (due to high radiation attenuation of that area). Suppose the nominal couch 82 speed (corresponding to m=1) is \tilde{v}. For projections with an inter-projection modulation factor m_{r,φ}, we modulate the couch 82 speed to be \tilde{v}/m_{r,φ}. The gantry 18 speed can be adjusted to be synchronized with the couch 82 according to the planned pitch to maintain a constant thread pitch. In this delivery mode, the delivered dose would be substantially the same as the planned dose but the delivery time is reduced from T=mNᵣN_{φ}\tilde{w} to

$$T = ( {\sum }_{r = 1}^{{N}_{r}} {\sum }_{φ = 1}^{{N}_{φ}} {m}_{r , φ} ) \tilde{w} \leq {mN}_{r} {N}_{φ} \tilde{w}$$

(1)
(e.g., if for patient body of 20 cm radius, PTV of 10 cm long and global modulation factor m=3). The normal delivery time for a 2.5 cm jaw width is 3×3 min=9 minutes. But if only about 10% of the projections have inter-projection modulation m_{r,φ}=3 and all others have m_{r,φ}≈1, then the total delivery time is reduced to (3×0.1+0.9)×3 min=3.6 minutes; almost the same as a non-modulated delivery (3 min). Dynamically adjusting the gantry 18 speed also can be used to achieve varied fluence intensity at certain angles.

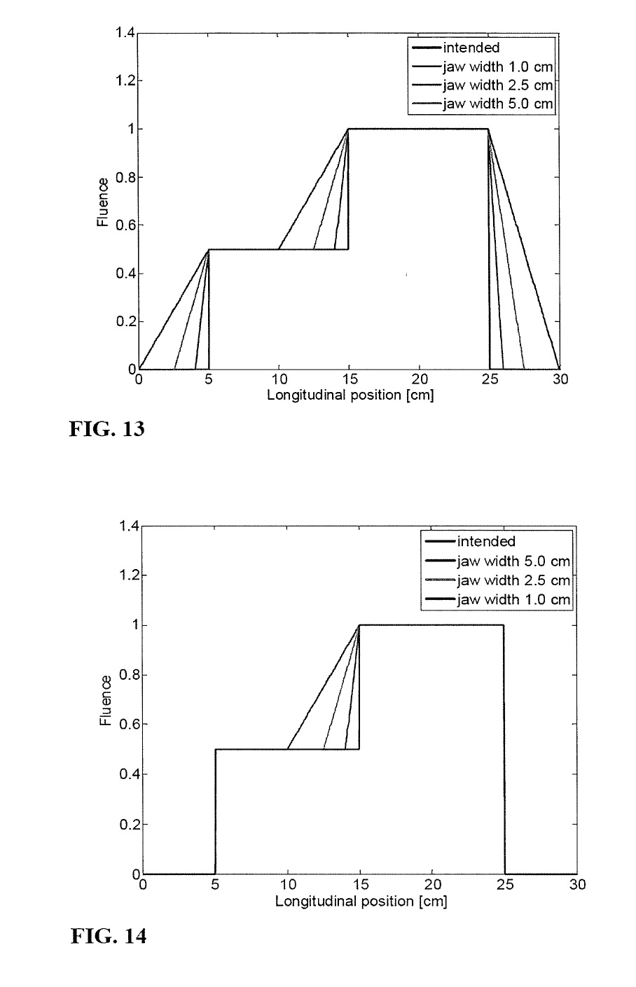

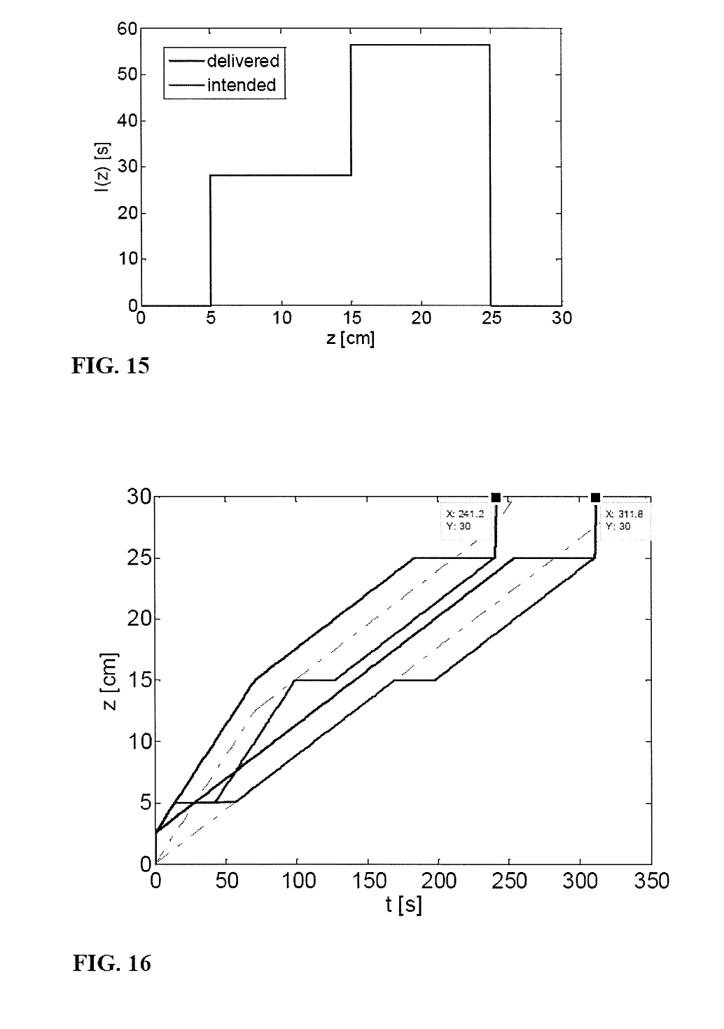

Using FIG. 13 as an example, the required fluence level or exposure time is lower in the region from 5 cm to 15 cm than in the region from 15 cm to 25 cm. Therefore, the couch 82 can move faster in this region, as graphically illustrated in FIG. 16. The left group of lines represents a dynamic couch treatment delivery, and the right group of lines in FIG. 16 represents a constant couch speed treatment delivery. Increasing the speed of the couch 82 in that region results in a steeper slope of the lines representing the tracks of the jaws 54, 58, and as illustrated in FIG. 16, the overall treatment time is reduced when the speed of the couch 82 is increased between 5 cm and 15 cm. Such a change in the required fluence level/exposure time could be due to changes in the thickness of the patient's body within the treatment area 38.

In some cases, such as the topotherapy delivery discussed above, couch 82 speed modulation itself is sufficient for a highly efficient delivery. In case of treatment delivery with couch 82 modulation only, we can still gain some efficiency by utilizing the factors that rotation modulations are less than global modulation mᵣ≦m. This can be very useful for very long target 38 volumes, such as whole body irradiation or radio-surgery cases where avoidance structures are scatted in certain rotation only. In this mode, the gantry 18 can rotate at the fixed speed while the couch 82 speed for each rotation is changed to:

v=\tilde{v}/┌mᵣ┐ (2)

Where ┌□┐ stands for the ceiling operation. The remaining modulation will be done by the multi-leaf collimator 62. In this operation mode, the delivered dose would be still the same as the planned dose, but with the delivery time change from T=mNᵣN_{φ}\tilde{w} to:

$$T = {\sum }_{r = 1}^{{N}_{r}} ⌈ {m}_{r} ⌉ \tilde{w} \leq {mN}_{r} {N}_{φ} \tilde{w}$$

(3)
(e.g., if for patient body of 20 cm radius, PTV of 80 cm long and global modulation factor m=3). The normal delivery time for a 2.5 cm jaw width is 3×24 min=72 minutes. But if only about 20% of the projections have inter-rotation modulation m_{r,φ}=3 and all others have m_{r,φ}≈1, then the total delivery time is reduced to (3×0.2+0.8)×24 min=33.6 minutes, which corresponds to substantially the same delivery time of global modulation factor m=1.4.

In another embodiment, the width of the jaws 42 (or to put another way, the size of the jaw aperture 50) is dynamically altered during the treatment of the target 38. Current treatment methods generally incorporate the use of a set jaw width 50 for the delivery of treatment to a particular target 38 or patient 14. The speed of the couch 82 is also generally kept constant in current treatment methods. Delivering the radiation to the patient 14 using a limited number of fixed jaw widths has the disadvantage of wasting radiation, causing inefficiency of the delivery process and can cause earlier end-of-life failures of certain components of the system 10 (such as portions of the multi-leaf collimator 62) due to a need to keep the radiation beam engaged for longer periods of time to effectively treat the patient 14. Further, the fixed jaw width 50 causes the normal tissue adjacent the target 38 to receive a ramp-up dose of radiation, thereby delivering more radiation than is necessary to that normal tissue. Using a small fixed jaw width 50 (such as 1 cm) can help reduce the ramp-up length and improve longitudinal dose conformity, but the smaller jaw width 50 results in a slower (and more inefficient) delivery. To reduce delivery time, it is optimal to open the jaws 46 as wide as possible to more fully utilize the radiation beam. FIG. 13 is a graphical illustration of the comparison of the intended longitudinal fluence distribution to the delivered distribution with different jaw widths 50 for fixed jaw width therapy.

Dynamic adjustment of the jaw width 50 during delivery of the treatment plan to the patient 14 achieves better efficiency and throughput, as well as maintaining the desired longitudinal dose conformity of the treatment delivery. Dynamic jaw delivery methods have the ability to utilize various jaw widths 50 for different beam fluence requirements. Larger jaw widths 50 can be used for regions where less intensity modulation (and a lower longitudinal resolution) is needed, increasing treatment efficiency. Tighter jaw widths 50 are used in regions where more modulation (and a higher longitudinal resolution) is required, improving the conformality of the dose delivered. One alternate treatment method, referred to by some as the running start and stop method, incorporates the use of dynamic jaw motion at the beginning and end of a treatment area (such as a target 38), while the jaws 46 remain at a fixed width during the middle of the treatment area 38 during the delivery of a treatment. FIG. 14 is a graphical comparison of the intended longitudinal fluence distribution to the delivered distribution with different jaw widths for running start and stop delivery.

However, the benefits of dynamically adjusting the width of the jaws 46 during treatment are even more pronounced when the jaws are adjusted dynamically along the entirety of the treatment area or target 38. For example, FIG. 15 is a graphical illustration comparing the intended longitudinal fluence distribution to the delivered distribution using any jaw width 50 in this type of dynamic jaw therapy.

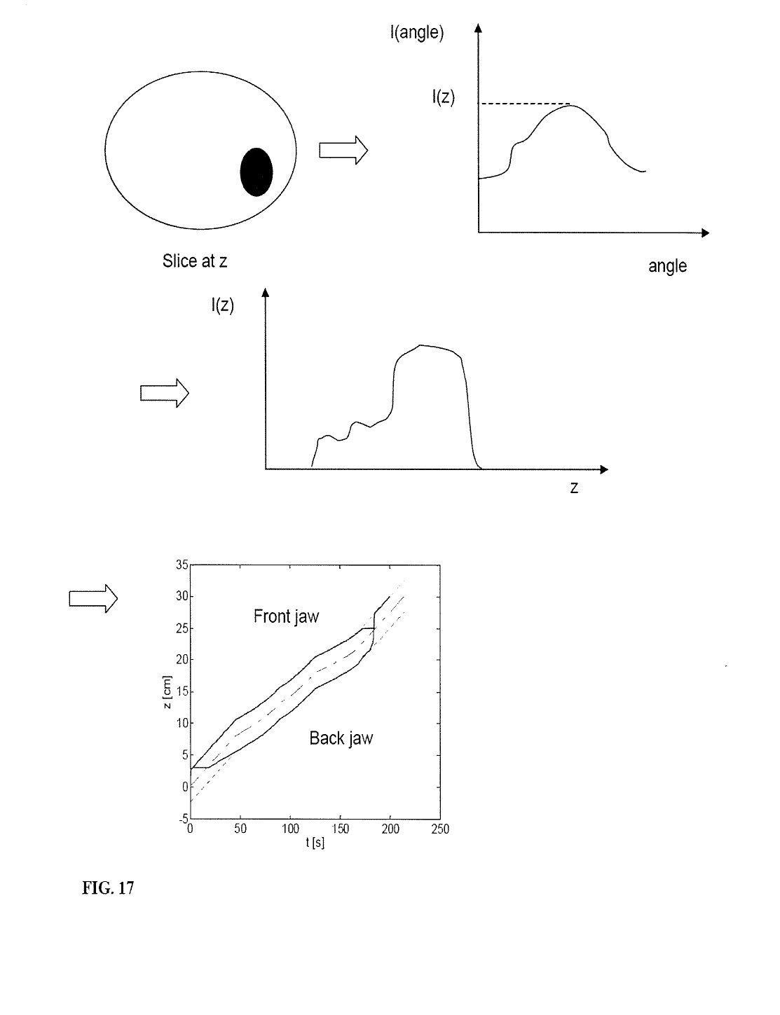

The workflow for calculating certain parameters of a dynamic jaw, dynamic couch treatment delivery is illustrated in FIG. 17. The first step is to obtain the exposure time at different angles for the slice at the longitudinal position of z. After such information has been calculated for every slice, the maximum exposure time I(z) for each slice can be obtained as a function of z. Finally, this I(z) can be used to calculate the tracks of the radiation source 24 and jaws 54, 58 such that the time interval between the back (upper) jaw 54 reaching position z and the front (lower) jaw 58 reaching position z equals I(z).

In one alternate treatment method, the width 50 of the jaws 46 is adjusted as necessary during the entire treatment while the speed of the couch 82 is kept constant. In another alternate method, the couch 82 speed is also dynamically altered, moving faster when the required dose rate is low and moving slower when the required dose rate is higher along the various portions of the target 38 being treated. In yet another alternate method, the jaw width 50 is altered symmetrically with respect to the central plane of the gantry rotation during the entirety of the treatment. The use of the dynamic symmetric jaw treatment can achieve the same fluence distribution as the dynamic (non-symmetric) jaw treatment with a slower couch speed to simplify the delivery. The couch 82 speed can also change to speed up the overall treatment delivery.

The dynamic jaw technique in general allows a wider jaw width setting to provide a treatment plan of similar quality to a plan using a more narrow jaw width. The dynamic couch speed technique allows the couch to move faster at certain regions where less fluence is needed to speed up the overall treatment delivery. In some cases, the reduction in treatment time (while delivering a treatment plan of similar dose conformity) is as much as 60% when compared to non-dynamic delivery techniques.

If we use dynamically variable jaw width, then finding the beam intensity at each projection is a multi-leaf collimator 62 segmentation issue. The optimization module 118 needs to reformulate optimization in this setting. Let c₁(t) denote the left (upper) jaw 54 position at time t, c₂ (t) the right (lower) jaw 58 position, v(t) couch speed, and I(t) intensity map (sinogram). Define the dose received at time t by x

b(t,x)=I(t)Π_{c}_{₂}_{(t)-c}_{₁}₍ₜ₎(x−v(t)) (4)

and the total dose received by x is

d(x)= [symbol] b(x,t)dt (5)

The objective is

∫|d(x)−dₚ(x)|dx (6)

And the constraints are

$$v ( t ) - \frac{w}{2} \leq {c}_{1} ( t ) \leq {c}_{2} ( t ) \leq v ( t ) + \frac{w}{2} \qquad ( 7 )$$

The following simple segmentation scheme seems to work. First, we consider only one MLC leaf 66 as the extension to multiple leaves is straightforward. Given a 1-D dose profile, the beam intensity is chosen to be the first one and the jaw width 50 is as wide as possible until the dose profile drops. For example, suppose the 1-D dose profile is 14352, our delivery strategy is

$$14352 \\ - \underline{11}$$

$$3352 \\ - \underline{333}$$

$$22 \\ - \underline{22}$$

$$0$$

In this example, the given length-5 dose profile is decomposed into 3 segments.

The software program 90 also includes a treatment delivery module 122 operable to instruct the radiation therapy treatment system 10 to deliver the treatment plan to the patient 14 according to the treatment plan. The treatment delivery module 122 calculates the appropriate pattern, position, and intensity of the radiation beam 30 to be delivered, to match the prescription as specified by the treatment plan. The pattern of the radiation beam 30 is generated by the modulation device 34, and more particularly by movement of the plurality of leaves in the multi-leaf collimator. The treatment delivery module 122 can utilize canonical, predetermined or template leaf patterns to generate the appropriate pattern for the radiation beam 30 based on the treatment parameters. The treatment delivery module 122 can also include a library of patterns for typical cases that can be accessed in which to compare the present patient data to determine the pattern for the radiation beam 30.

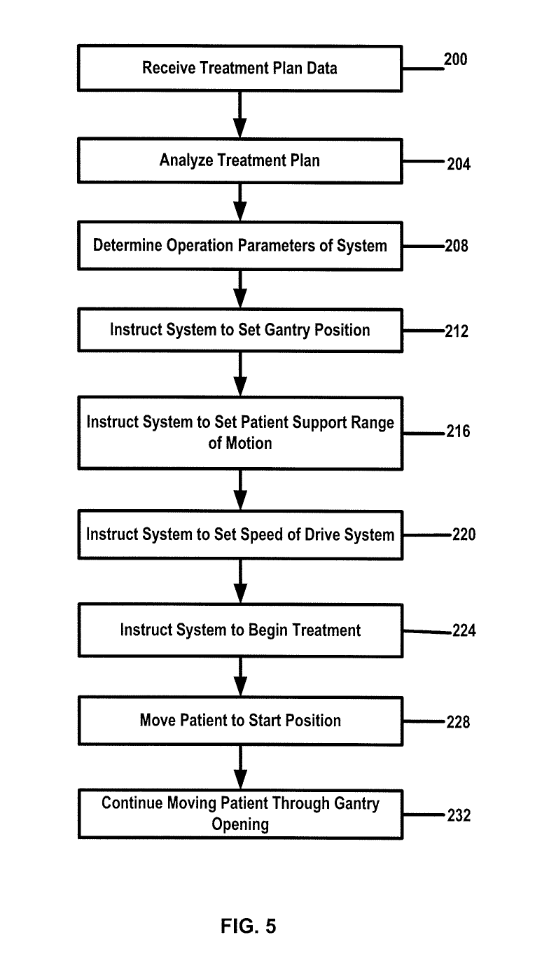

FIG. 5 is a flow chart of a method of treating a patient 14 with radiation therapy. Based on the treatment plan, the optimization module 118 communicates with the radiation therapy treatment system 10 to set the operational parameters. The optimization module 118 receives (at 200) the treatment plan from the treatment plan module 106. The optimization module 118 analyzes (at 204) the treatment plan and data input to the optimization module 118. Based on the treatment plan and the treatment method, the optimization module 118 determines (at 208) the operational parameters of the radiation therapy treatment system 10. The optimization module 118 instructs (at 212) the system 10 to set the position or angle of the gantry 18. The optimization module also instructs (at 216) the system 10 to set the range of motion for the couch 82 and instructs (at 220) the system 10 to set the speed of the drive system 86. After treatment begins, the speed of the drive system and direction of the couch 82 may vary from the originally set position during treatment delivery. The treatment delivery module 122 instructs (at 224) the system 10 to begin radiation therapy treatment according to the treatment plan. The drive system 86 moves (at 228) the patient 14 via the couch 82 to the start position. During treatment, the drive system 86 moves (at 232) the patient 14 via the couch 82 through the gantry opening while the gantry 18 remains in a fixed position and while the radiation source 24 delivers the radiation beam 30 to the target 38.

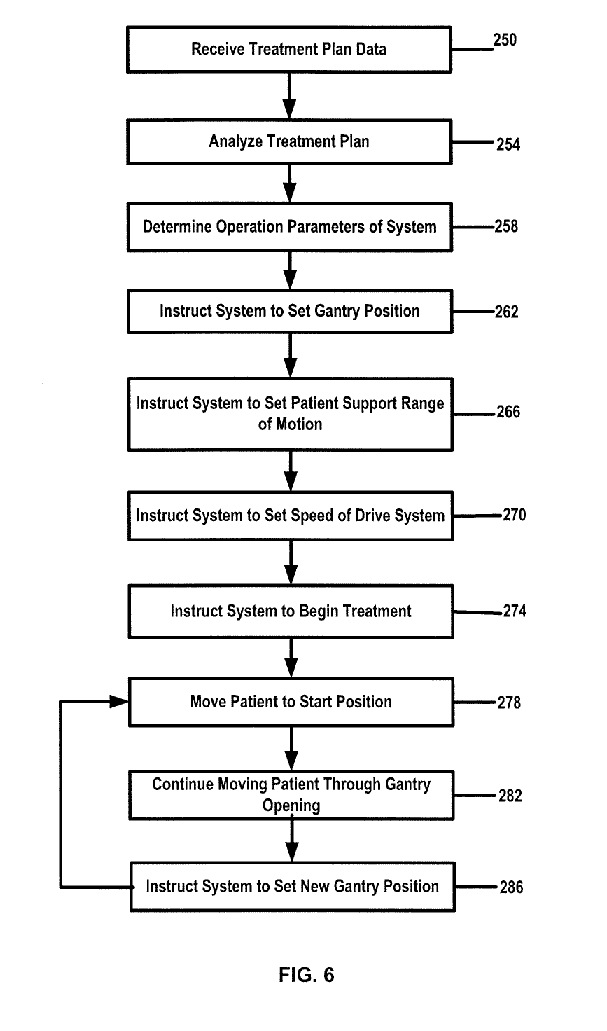

FIG. 6 is a flow chart of a method of treating a patient 14 with radiation therapy. The treatment plan may call for the patient 14 to travel through the gantry opening multiple times and multiple trajectories of the radiation beam. In this aspect of operation, the optimization module 118 receives (at 250) the treatment plan from the treatment plan module 106. The optimization module 118 analyzes (at 254) the treatment plan and data input to the optimization module 118. Based on the treatment plan and the treatment method, the optimization module 118 determines (at 258) the operational parameters of the radiation therapy treatment system 10. The optimization module 118 instructs (at 262) the system 10 to set the position or angle of the gantry 18. The optimization module also instructs (at 266) the system 10 to set the range of motion for the couch 82 and instructs (at 270) the system 10 to set the speed of the drive system 86. After treatment begins, the speed of the drive system and direction of the couch 82 may vary from the originally set position during treatment delivery. The treatment delivery module 122 instructs (at 274) the system 10 to begin radiation therapy treatment according to the treatment plan. The drive system 86 moves (at 278) the patient 14 via the couch 82 to the start position.

During treatment, the drive system 86 moves (at 282) the patient 14 via the couch 82 in a first direction through the gantry opening while the gantry 18 remains in a fixed position and while the radiation source 24 delivers the radiation beam 30 to the target 38. The optimization module 118 instructs (at 286) the system 10 to set the next position or angle of the gantry 18. The range of motion of the couch 82 and the speed of the drive system 86 may also be updated or modified for the second pass through the gantry opening. Steps 278, 282, and 286 can be repeated as determined by the treatment plan. The radiation therapy treatment system 10 can store the treatment specifications, such as amount of radiation delivered to the patient 14, range of motion of the couch 82, gantry angles employed during the treatment session, and MLC parameters. The information recorded at the end of the treatment can be used to set the parameters for subsequent treatment fractions.

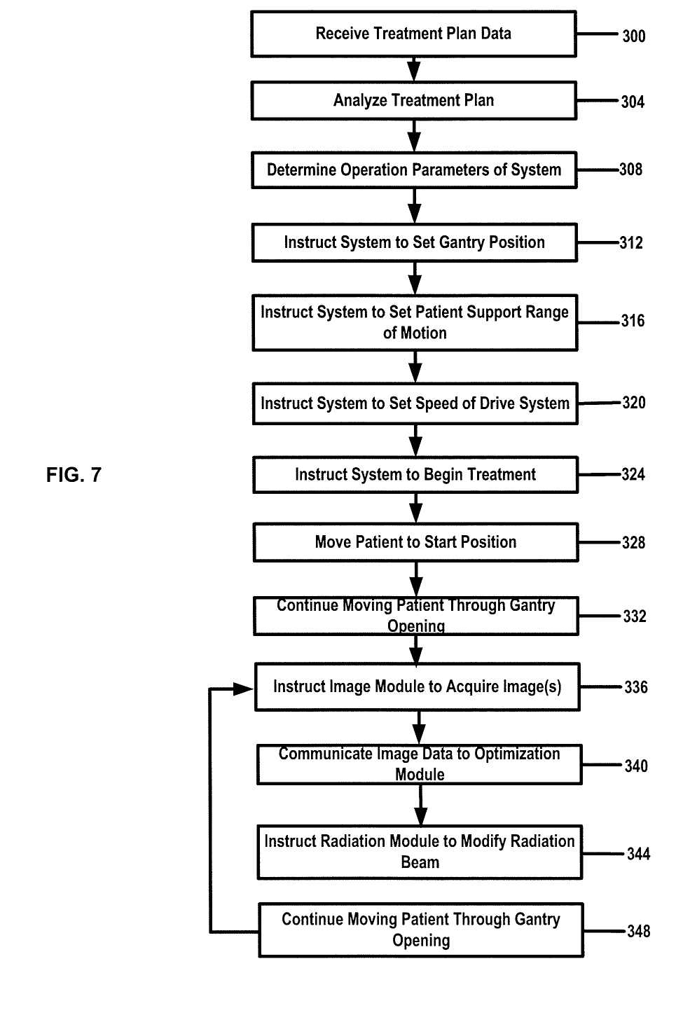

FIG. 7 is a flow chart of a leaf flashing method of delivering radiation treatment to a patient 14. Based on the treatment plan, the optimization module 118 communicates with the radiation therapy treatment system 10 to set the operational parameters. The optimization module 118 receives (at 300) the treatment plan from the treatment plan module 106. The optimization module 118 analyzes (at 304) the treatment plan and data input to the optimization module 118. Based on the treatment plan and the treatment method, the optimization module 118 determines (at 308) the operational parameters of the radiation therapy treatment system 10. The optimization module 118 instructs (at 312) the system 10 to set the position or angle of the gantry 18. The optimization module also instructs (at 316) the system 10 to set the range of motion for the couch 82 and instructs (at 320) the system 10 to set the speed of the drive system 86. After treatment begins, the speed of the drive system and direction of the couch 82 may vary from the originally set position during treatment delivery. The treatment delivery module 122 instructs (at 324) the system 10 to begin radiation therapy treatment according to the treatment plan. The drive system 86 moves (at 328) the patient 14 via the couch 82 to the start position.

During treatment, the drive system 86 moves (at 332) the patient 14 via the couch 82 through the gantry opening while the gantry 18 remains in a fixed position and while the radiation source 24 delivers the radiation beam 30 to the target 38. During treatment, and either while the couch 82 is slowed or stopped, the optimization module 118 instructs (at 336) the image module 114 to acquire an image(s) of at least a portion of the patient 14. As the patient 14 receives radiation treatment, the target 38 may change due to bodily functions of the patient 14, such as breathing. The image module 114 communicates (at 340) the acquired image data to the optimization module 118. The optimization module 118 instructs (at 344) the radiation module 22 to modify the radiation beam 30 to accommodate the changes in the target 38 based on the image data. Often, the parameters of the radiation beam 30 are adjusted to encompass a larger target 38 due to the changes in the patient's anatomy. The optimization module 118 instructs (at 348) the couch 82 to resume prescribed speed or operation. As the patient's anatomy changes throughout the treatment, steps 336, 340, 344, and 348 can be repeated according to the treatment plan.

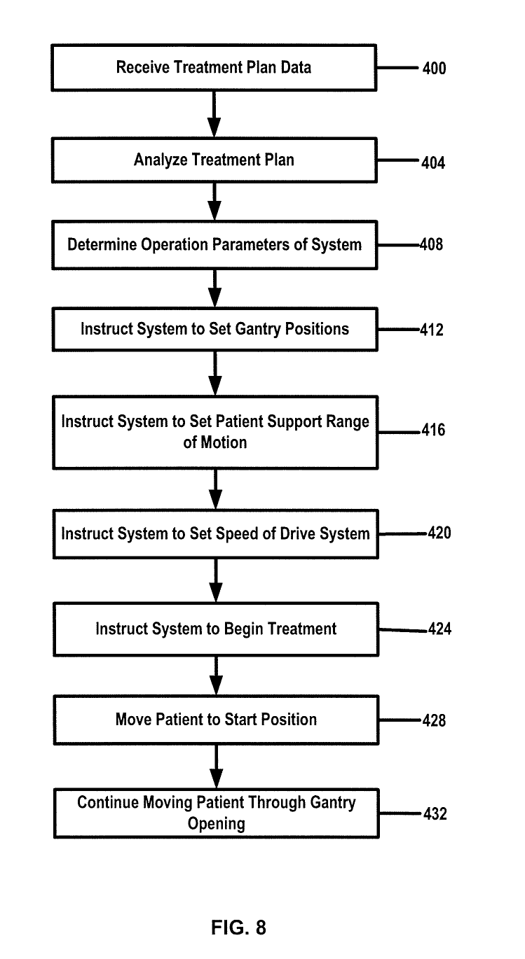

FIG. 8 is a flow chart of the dynamic tangent method for delivering radiation treatment. Based on the treatment plan, the optimization module 118 communicates with the radiation therapy treatment system 10 to set the operational parameters. The optimization module 118 receives (at 400) the treatment plan from the treatment plan module 106. The optimization module 118 analyzes (at 404) the treatment plan and data input to the optimization module 118. Based on the treatment plan and the treatment method, the optimization module 118 determines (at 408) the operational parameters of the radiation therapy treatment system 10. The optimization module 118 instructs (at 412) the system 10 to set the first position and second position of the gantry 18 to define a path of travel of the gantry 18. The optimization module also instructs (at 416) the system 10 to set the range of motion for the couch 82 and instructs (at 420) the system 10 to set the speed of the drive system 86. After treatment begins, the speed of the drive system and direction of the couch 82 may vary from the originally set position during treatment delivery. In one aspect, the angular speed of the gantry 18 can be determined so that the gantry 18 reaches the second position substantially at the same time as the couch 82 reaches the end position defined by the range of motion of the couch 82. The treatment delivery module 122 instructs (at 424) the system 10 to begin radiation therapy treatment according to the treatment plan. The drive system 86 moves (at 428) the patient 14 via the couch 82 to the start position. During treatment, the drive system 86 moves (at 432) the patient 14 via the couch 82 through the gantry opening while the gantry 18 rotates from the first position to the second position and while the radiation source 24 delivers the radiation beam 30 to the target 38.

As described above, while the patient 14 receives treatment, the optimization module 118 can instruct the image module 114 to acquire an image(s) of the patient 14. The image module 114 can transfer the acquired image data to the optimization module 118. The optimization module 118 can instruct the radiation module 22 to modify the radiation beam 30 to accommodate the changes in the target 38 based on the image data. Also as described above, treatment specifications can be recorded to be used in subsequent treatment fractions.

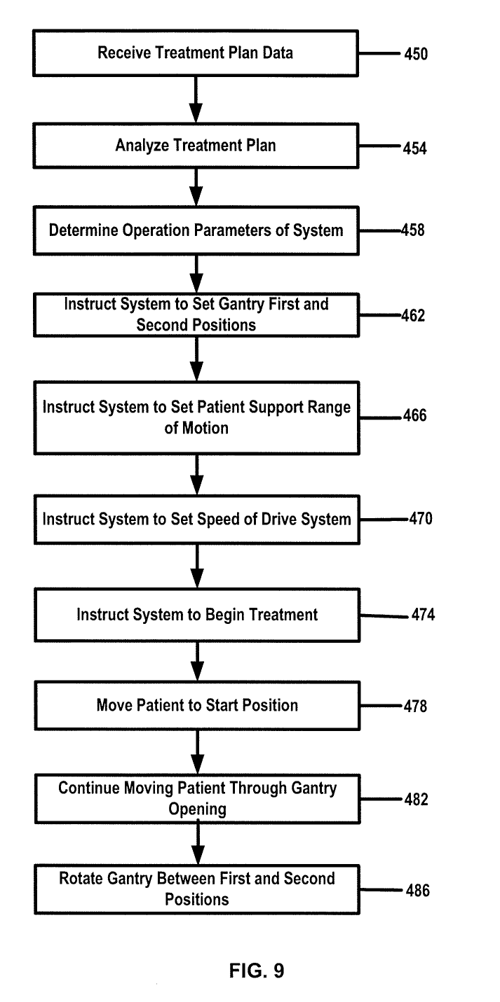

FIG. 9 is a flow chart of the rocking gantry method for delivering radiation treatment to a patient 14. Based on the treatment plan, the optimization module 118 communicates with the radiation therapy treatment system 10 to set the operational parameters. The optimization module 118 receives (at 450) the treatment plan from the treatment plan module 106. The optimization module 118 analyzes (at 454) the treatment plan and data input to the optimization module 118. Based on the treatment plan and the treatment method, the optimization module 118 determines (at 458) the operational parameters of the radiation therapy treatment system 10. The optimization module 118 instructs (at 462) the system 10 to set the first position and second position of the gantry 18 to define a path of travel of the gantry 18. The optimization module also instructs (at 466) the system 10 to set the range of motion for the couch 82 and instructs (at 470) the system 10 to set the speed of the drive system 86. After treatment begins, the speed of the drive system and direction of the couch 82 may vary from the originally set position during treatment delivery. The treatment delivery module 122 instructs (at 474) the system 10 to begin radiation therapy treatment according to the treatment plan. The drive system 86 moves (at 478) the patient 14 via the couch 82 to the start position. During treatment, the drive system 86 moves (at 482) the patient 14 via the couch 82 through the gantry opening while the gantry 18 rotates (at 486) between the first position and the second position and while the radiation source 24 delivers the radiation beam 30 to the target 38.

As described above, while the patient 14 receives treatment, the optimization module 118 can instruct the image module 114 to acquire an image(s) of the patient 14. The image module 114 can transfer the acquired image data to the optimization module 118. The optimization module 118 can instruct the radiation module 22 to modify the radiation beam 30 to accommodate the changes in the target 38 based on the image data. Also as described above, treatment specifications can be recorded to be used in subsequent treatment fractions.

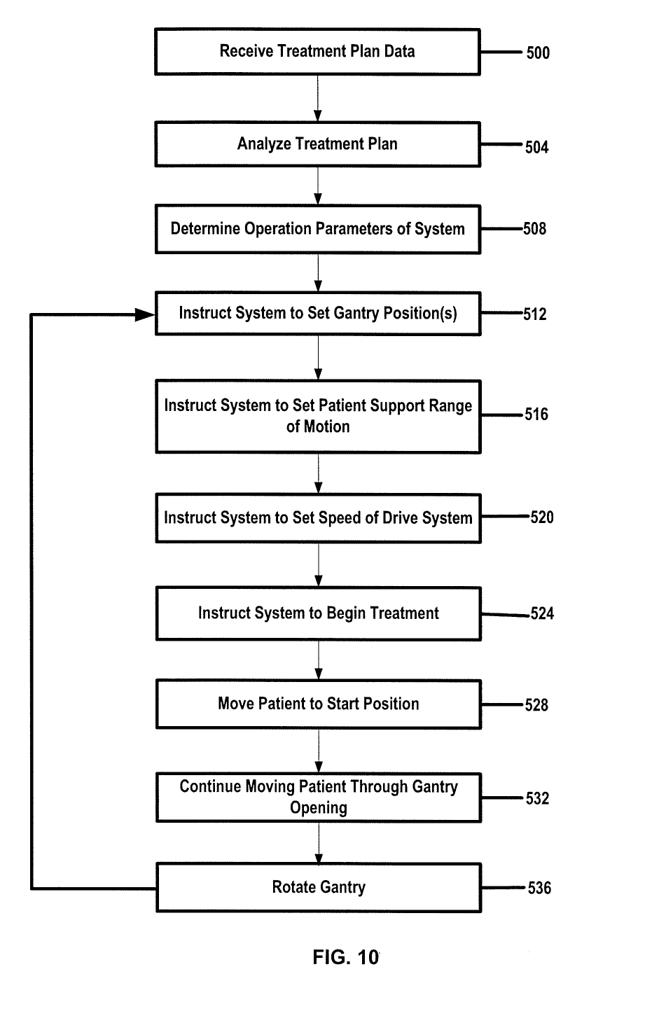

FIG. 10 is a flow chart of the multi-region treatment method, which may incorporate more than one radiation therapy delivery method. Based on the treatment plan, the optimization module 118 communicates with the radiation therapy treatment system 10 to set the operational parameters. The optimization module 118 receives (at 500) the treatment plan from the treatment plan module 106. The optimization module 118 analyzes (at 504) the treatment plan and data input to the optimization module 118. Based on the treatment plan and the treatment method, the optimization module 118 determines (at 508) the operational parameters of the radiation therapy treatment system 10 for each of the targets 38 to be treated. Based on the first target 38 to be treated, the optimization module 118 instructs (at 512) the system 10 to set the first position and second position of the gantry 18 to define a path of travel of the gantry 18. The optimization module also instructs (at 516) the system 10 to set the range of motion for the couch 82 and instructs (at 520) the system 10 to set the speed of the drive system 86.

After treatment begins, the speed of the drive system and direction of the couch 82 may vary from the originally set position during treatment delivery. The treatment delivery module 122 instructs (at 524) the system 10 to begin radiation therapy treatment according to the treatment plan. The drive system 86 moves (at 528) the patient 14 via the couch 82 to the start position. During treatment, the drive system 86 moves (at 532) the patient 14 via the couch 82 through the gantry opening while the gantry 18 rotates (at 536) between the first position and the second position and while the radiation source 24 delivers the radiation beam 30 to the target 38. After the first target 38 has been treated, the couch 82 can be slowed or stopped and steps 512-536 can be repeated for the second target 38. The second target 38 may receive treatment based on a different method of treatment as described above (e.g., topotherapy, dynamic tangent, rocking gantry, etc.).

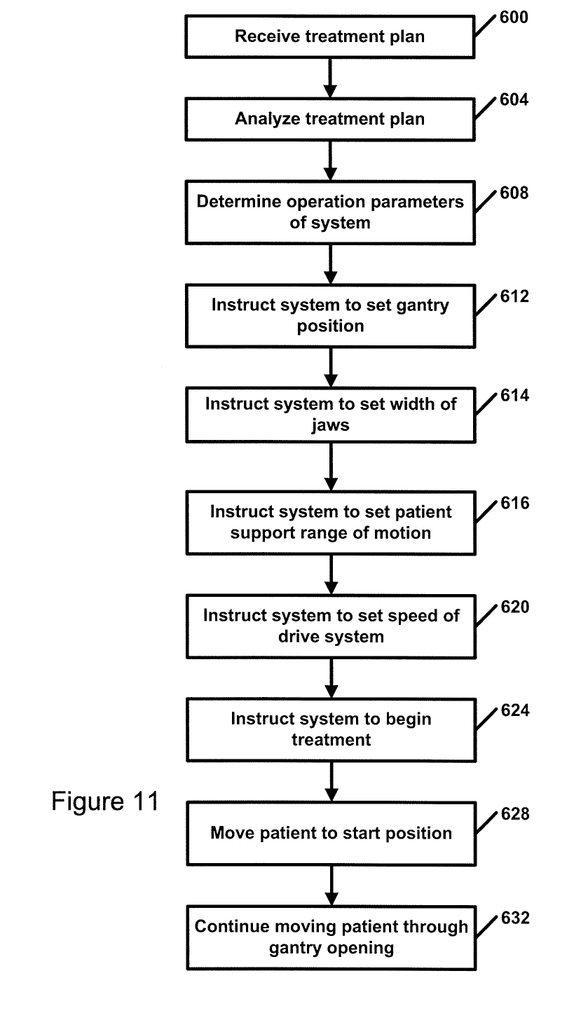

FIG. 11 is a flow chart of the dynamic jaw method of treating a patient 14 with radiation therapy. Based on the treatment plan, the optimization module 118 communicates with the radiation therapy treatment system 10 to set the operational parameters. The optimization module 118 receives (at 600) the treatment plan from the treatment plan module 106. The treatment plan may be pre-optimized according to the methods discussed above. The optimization module 118 analyzes (at 604) the treatment plan and data input to the optimization module 118. Based on the treatment plan and the treatment method, the optimization module 118 determines (at 608) the operational parameters of the radiation therapy treatment system 10. The optimization module 118 instructs (at 612) the system 10 to set the starting position or angle of the gantry 18, and instructs (at 614) the system 10 to set the starting width of the jaws 46. The optimization module also instructs (at 616) the system 10 to set the range of motion for the couch 82 and instructs (at 620) the system 10 to set the starting speed of the drive system 86. After treatment begins, the speed of the drive system and direction of the couch 82 and/or the width of the jaws 46 may vary from the originally set position during treatment delivery based on information from the optimization module 118. The treatment delivery module 122 instructs (at 624) the system 10 to begin radiation therapy treatment according to the treatment plan. The drive system 86 moves (at 628) the patient 14 via the couch 82 to the start position. During treatment, the drive system 86 moves (at 632) the patient 14 via the couch 82 through the gantry opening while the gantry 18 remains in a fixed position and while the radiation source 24 delivers the radiation beam 30 to the target 38.

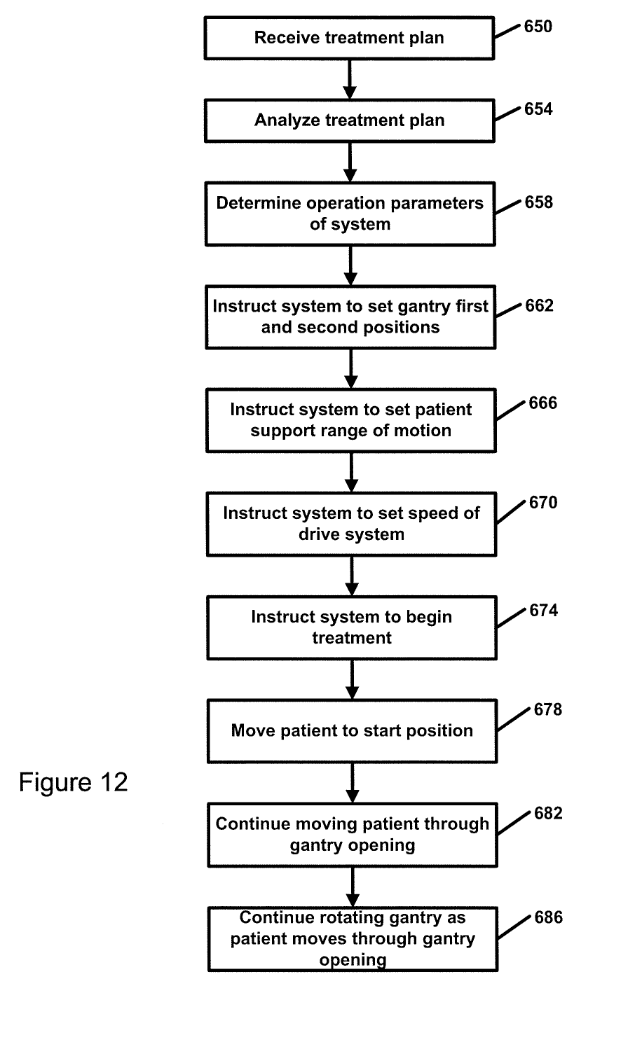

FIG. 12 is a flow chart of the dynamic jaw method for delivering radiation treatment to a patient 14 utilizing a moving gantry. Based on the treatment plan, the optimization module 118 communicates with the radiation therapy treatment system 10 to set the operational parameters. The optimization module 118 receives (at 650) the treatment plan from the treatment plan module 106. The optimization module 118 analyzes (at 654) the treatment plan and data input to the optimization module 118. Based on the treatment plan and the treatment method, the optimization module 118 determines (at 658) the operational parameters of the radiation therapy treatment system 10. The optimization module 118 instructs (at 662) the system 10 to set the first position and second position of the gantry 18 to define a path of travel of the gantry 18. The optimization module also instructs (at 666) the system 10 to set the range of motion for the couch 82 and instructs (at 670) the system 10 to set the starting speed of the drive system 86. After treatment begins, the speed of the drive system and direction of the couch 82, as well as the width of the jaws 46 and/or the speed of the gantry 18 may vary from the originally set position during treatment delivery. The treatment delivery module 122 instructs (at 674) the system 10 to begin radiation therapy treatment according to the treatment plan. The drive system 86 moves (at 678) the patient 14 via the couch 82 to the start position. During treatment, the drive system 86 moves (at 682) the patient 14 via the couch 82 through the gantry opening while the gantry 18 rotates (at 686) and while the radiation source 24 delivers the radiation beam 30 to the target 38.

As described above, while the patient 14 receives treatment, the optimization module 118 can instruct the image module 114 to acquire an image(s) of the patient 14. The image module 114 can transfer the acquired image data to the optimization module 118. The optimization module 118 can instruct the radiation module 22 to modify the radiation beam 30 to accommodate the changes in the target 38 based on the image data. Also as described above, treatment specifications can be recorded to be used in subsequent treatment fractions.

After the patient's first treatment, the same treatment plan can be used for future treatments. Subsequent fractions of the treatment plan can be modified or optimized. For example, the treatment plan can be modified to account for anatomical changes and to remedy errors in the process. In addition, subsequent fractions of the treatment plan can be modified to account for cumulative dose delivered to the target(s) 38. The fractions of the treatment plan can be modified to incorporate the effects of deformation and biological information. The fractions of the treatment plan can be additionally modified based on the initial acquired CT images or based on subsequently acquired CT images. In some embodiments, the system 10 can intersperse image acquisition phases into a radiation therapy treatment plan. This is performed by stopping the couch during a helical or topographic treatment to collect images (and simultaneously gating, stopping, or blocking radiation to the patient), imaging between passes of a multi-pass treatment, imaging between gantry angles or portals of a step-and-shoot type delivery, or imaging between arcs of an IMAT delivery. The system 10 can also provide for treatment verification through dose calculation performed concurrent with delivery of the treatment plan, through dose reconstruction incorporating detector exit data, through recalculation of dose in a 4D image based upon measurements of a patient's motion during treatment, or through modification of the treatment plan in real time or performed retrospectively based upon 4D dose calculation, and/or comparison of 4D dose calculation to the planned delivery. In the case of dose reconstruction through the use of exit data, the exit data can come from a detector such as, for example, a single-row gas ionization detector (e.g., xenon), a multi-row gas ionization detector, a crystal detector, a solid state detector, a flat panel detector (e.g., Amorphous silicon or selenium), or other suitable detecting devices.

Various features of the invention are set forth in the following claims.

What is claimed is:

1. A method of delivering a radiation therapy treatment plan to a treatment area of a patient using a radiation therapy system including a moveable support for supporting the patient and a gantry moveable relative to the support, the gantry supporting a radiation source, a set of jaws having a jaw width and a multi-leaf collimator for modulating the radiation during delivery of the treatment plan, the method comprising:
moving the support along an axis during delivery of the treatment plan to the treatment area; and
dynamically adjusting the width of the jaws during delivery of the treatment plan to the treatment area;
wherein the adjustment of the width of the jaws can occur along the entirety of the delivery of the treatment plan to the treatment area, and wherein the adjustment of the width of the jaws modulates the radiation during delivery of the treatment plan.

2. The method of claim 1, wherein the support is moved at varying speeds during the delivery of the treatment plan.

3. The method of claim 1, wherein the gantry is moved relative to the support during the delivery of the treatment plan.

4. The method of claim 3, wherein the gantry is moved at varying speeds during the delivery of the treatment plan.

5. The method of claim 1, wherein adjusting the width of the jaws comprises symmetric adjustment of the jaws about a plane.

6. The method of claim 1, wherein the support is movable at varying speeds during the delivery of the treatment plan, the gantry is movable at varying speeds during the delivery of the treatment plan, and wherein any combination of the dynamic adjustment of the width of the jaws, varying the speed of the movement of the movable support and varying the speed of the movement of the gantry can be done simultaneously during the delivery of the treatment plan.

7. The method of claim 1, wherein the support is moved at a constant speed during the delivery of the treatment plan.

8. A method of delivering a radiation therapy treatment plan to a treatment area of a patient using a radiation therapy system including a moveable support for supporting the patient and a gantry moveable relative to the support, the gantry supporting a radiation source, a set of jaws having a jaw width and a multi-leaf collimator for modulating the radiation during delivery of the treatment plan, the method comprising:
moving the support along an axis at varying speeds during delivery of the treatment plan to the treatment area; and
moving the gantry relative to the support at varying speeds during the delivery of the treatment plan.

9. The method of claim 8, further comprising dynamically adjusting the width of the jaws during the delivery of the treatment plan.
